(19) United States
(12) Patent Application Publication
(10) Pub. No.: US 2026/0000963 A1
(43) Pub. Date: Jan. 1, 2026

(54) Re-programmable Universal Playing Card Deck and Board Game Surface

(71) Applicant: Michael Molinari, New London, CT (US)

(72) Inventor: Michael Molinari, New London, CT (US)

(21) Appl. No.: 19/257,082

(22) Filed: Jul. 1, 2025

Related U.S. Application Data
(60) Provisional application No. 63/666,562, filed on Jul. 1, 2024.

(51) Int. Cl. A63F 1/02; B41M 5/00

(52) U.S. Cl. CPC A63F 1/02; B41M 5/0052; A63F 2001/022

(57) ABSTRACT

According to some embodiments, a gaming system includes a first shaped game piece capable of receiving a reversible pigment and a second shaped game piece capable of receiving a reversible pigment. The first shaped game piece and the second shaped game piece comprise a same shape and the reversible pigment comprises a thermochromatic pigment.

### BACKGROUND

Card games and board games are normally permanently printed on a card stock material or cardboard and cards and/or boards for games can easily be lost and damaged. Cards and/or boards for games also take up lots of physical space. Each set of cards and game board is only usable for playing a single game and cannot easily be adapted to playing other games using the same physical cards and game board. Currently, gamers must purchase multiple unique games that will spend most of their time sitting on a shelf. These games can be lost and damaged and are not well-suited for travelers or people with limited storage space.

It would therefore be desirable to provide a single game system that can be substituted for multiple unique games.

### SUMMARY

Some embodiments described herein relate to a gaming system that includes a first shaped game piece capable of receiving a reversible pigment and a second shaped game piece capable of receiving a reversible pigment. The first shaped game piece and the second shaped game piece comprise a same shape and the reversible pigment comprises a thermochromatic pigment.

### BRIEF DESCRIPTION OF THE DRAWINGS

FIG. 1 illustrates a software interface in accordance with some embodiments.

FIG. 2 illustrates a method according to some embodiments.

FIG. 3 illustrates a printer and a plurality of game pieces in accordance with some embodiments.

FIG. 4 illustrates a game board in accordance with some embodiments.

FIG. 5 illustrates a device in accordance with some embodiments.

FIG. 6 illustrates cold storage in accordance with some embodiments.

### DETAILED DESCRIPTION

In the following detailed description, numerous specific details are set forth in order to provide a thorough understanding of the embodiments. However, it will be understood by those of ordinary skill in the art that the embodiments may be practiced without these specific details. In other instances, well-known methods, procedures, components and circuits have not been described in detail so as not to obscure the embodiments.

The present embodiments relate to a game system that may reduce a need for purchasing multiple unique game sets. The game system comprises a same set of cards and board pieces may be reused for different games by being able to change game information located on the set of cards and board pieces (e.g., artwork, words, numbers, other game related information). This may result in substantial cost savings for users as well as other advantages that will be described later in this document.

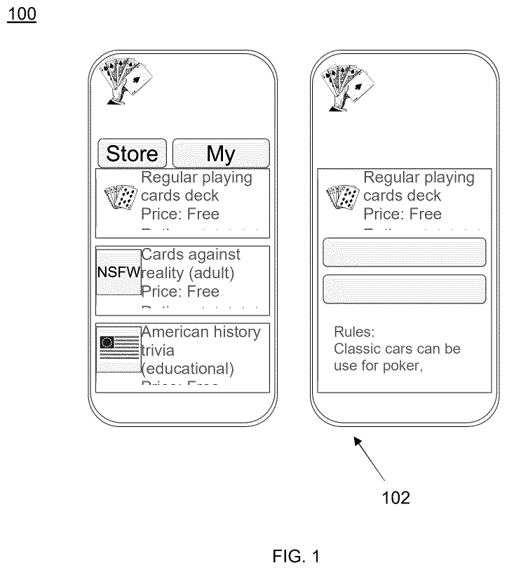

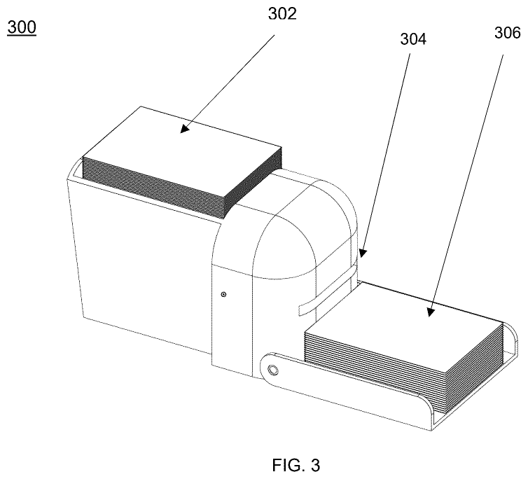

Now referring to FIG. 1, an embodiment of a gaming interface 100 is illustrated. The gaming interface 100 may comprise a software interface that is operated on a device such as device 102. As illustrated in FIG. 1, the device 102 may comprise, but is not limited to, a mobile phone, tablet, a laptop or a desktop may be electrically coupled to a printer (not shown in FIG. 1) via a network. The network may comprise any wired or wireless network that may be used for communication purposes between electronic devices. For example, the network may comprise, but is not limited to, a universal serial bus (USB) connection, a hard-wired connection, a wired and/or wireless mesh network, LAN, MAN, or WAN. In some the gaming interface 100 may be part of a printer, as described with respect to FIG. 3 and thus the printer and the game interface may comprise a single device. The gaming interface 100 may be used to send commands to a printer to print on re-writable playing cards and re-writable interlocking board pieces. The gaming interface 100 may also be used to facilitate writing on other re-writable surfaces used in gameplay (e.g., dice, player tokens, spin wheels, game objects with planar surfaces, etc.). The gaming interface 100 may comprise (i) software for managing and retrieving/printing the artwork for games, (ii) software to manage a game library, (iii) software for tracking license purchases of games, (iv) software for game creators to publish games into a game catalog for distribution and (v) software for game developers to add interactive features to games, such as, but not limited to, modifying cards over the course of gameplay.

The gaming interface 100 may access a game library that may be used for tracking license purchases for various games. The game library may be stored locally or it may comprise a centralized gaming library that may be accessed by the gaming interface 100 over a network. The game library may further be used by game creators to publish games into a game catalog for distribution to user devices.

The gaming interface 100 may further utilize software for (i) managing and retrieving artwork for various games and tracking license purchases of games, (ii) adding interactive features to games, such as modifying cards over the course of gameplay, (iii) game authoring tools for game developers, and (iv) allowing publishers to set prices, upload artwork, capture rules, and track game status.

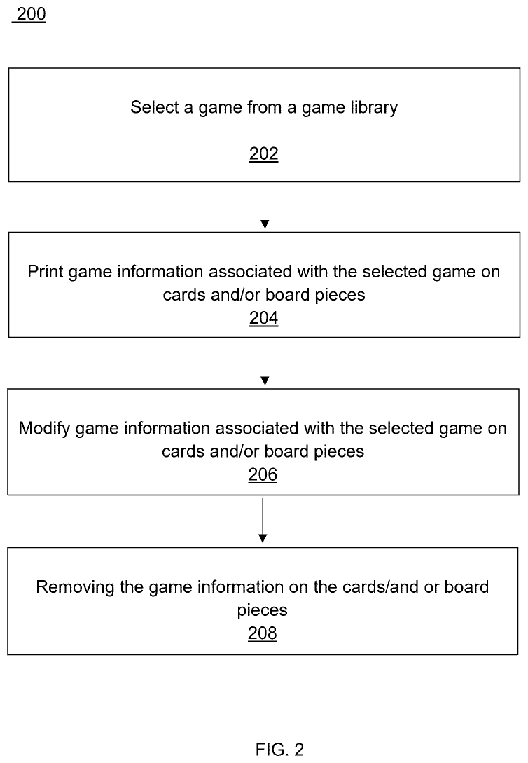

Now referring to FIG. 2, a method 200 that might be performed by a user using the gaming interface described with respect to FIG. 1 is illustrated according to some embodiments. The method described herein does not imply a fixed order to the steps, and embodiments of the present invention may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

Method 200 may relate using re-programable playing cards (“cards”) and re-programmable board pieces (“board pieces) for a board game. Now referring to 210, a user selects a game from a game library. At 220, game information associated with the selected game may be printed on the cards and/or board pieces (i.e., game pieces that come in various shapes and sizes). For example, game pieces may comprise any planar object such as, but not limited to, cards, dice, board pieces, player tokens, and spin wheels. The cards may be playing card shaped. For example, in some embodiments, the playing cards may be 2.5 inches by 3.5 inches. The board pieces may be any shape that can fit into a printer, such as a thermal printer. The cards and board pieces may be comprised of plastic, paper, cardboard, card stock or combinations thereof. In some embodiments, the cards and board pieces may be treated with a reversible thermochromatic pigment that permits using a thermal printer to reprint game information (e.g., artwork) on the cards and board pieces. When users (e.g., gamers or players) are done playing a selected game, the cards and/or board pieces may be reset, at 208, by removing the game information on the cards/and or board pieces.

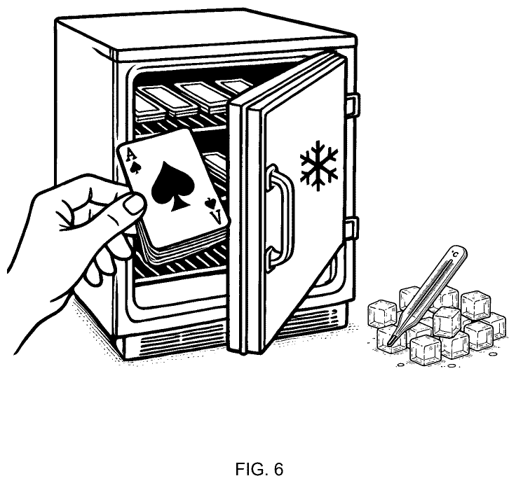

In some embodiments, removing the game information on cards/and or board pieces may comprise cooling the cards/and or board pieces to a point where the pigment fades. For example, the cards/and or board pieces may be placed in a cold storage such as a freezer, cooler or icebox as illustrated in FIG. 6. In some embodiments, instead of using a pigment that is sensitive to heat/cold, the cards and/or board pieces may use a re-writeable display such as e-ink which is a display technology that mimics the appearance of ink on paper. E-ink generally comprises low power consumption and does not need the use of a backlight so that the image can be maintained without power. When e-ink is used for the cards and/or board pieces, software associated with the gaming interface 100 may comprise a feature for resetting the cards and/or board pieces to a blank state. In another embodiment, a thermochromatic pigment may be one of many varieties. In some embodiments, a thermochromatic pigment may be erased (reset) with prolonged exposure to a high temperature and can be printed (programmed) with a short burst at high temperature. In this embodiment, there would be no need for cold storage to reset the cards or game pieces. Therefore, depending on the type of thermochromatic pigment used, a card can be erased based on a set temperature for a set period of time.

For purposes of illustrating features of the present embodiments, some simple examples will now be introduced. Those skilled in the art will recognize that these examples are illustrative and are not limiting and are provided purely for explanatory purposes. In some embodiments, the device 102 may contain, or be able to access via a network, a digital library of games. Thus, in this example a family may gather for their weekly game night. Using the software on their device 102, they select a game (e.g., a classic board game) from their digital library. The artwork for the game (e.g., artwork for a game board and playing cards) is sent to their printer (e.g., a thermal printer), which may print the necessary components (e.g., artwork) onto a set of reusable cards and/or reusable interlocking board pieces. Once the family finishes playing the game, they store the pieces back in a box. The next week, they choose a different game from their library, reset the cards and board (as will be described herein) and print the new game's artwork, ready for another fun evening.

In a second example, a group of friends is going on a road trip. Instead of packing multiple bulky board games, they bring a set of reusable cards and interlocking board pieces along with a compact thermal printer. Using their smartphone, they access their game library and print a variety of games to play during their trip. The games can easily be reset and reprinted as needed, providing endless entertainment without taking up much space.

Referring back to FIG. 2, at 206 in some embodiments where the game cards and/or board pieces might change while playing the game, game information on cards and/or board pieces may be modified. This may happen in real time while the players are playing the game.

In a third example, relating to element 206, a teacher, in a classroom setting, may use the gaming interface to select educational games designed to teach math and language skills. The artwork for the games is printed onto the cards and board pieces. Students engage with interactive and customizable learning activities. During the lesson, the teacher may modify the cards in real-time to add new challenges or track student progress. After the lesson, the cards and board pieces are reset for the next class.

In a fourth example, also relating to element 206, a game developer releases a new strategy game where players can earn power-ups and modify game elements based on their progress. Players may use the software associated with the game interface to print the initial game setup. As they play, they earn power-ups that can be printed onto the cards immediately, tracking their progress and making each session unique. The software associated with the game interface may allow for continuous updates and customization, enhancing the overall gaming experience.

Besides the cost savings inherent in reducing the need for purchasing multiple unique game sets, since the same set of cards and board pieces can be reused for different games as described above, the embodiments described herein comprise several other advantages. For one, traditional board games and card games take up a lot of physical space. The embodiments described herein may be stored in a compact form, freeing up valuable storage space and making it ideal for those with limited space. Secondly, by using materials treated with reversible thermochromatic pigments or e-ink displays, cards and/or board pieces are less prone to wear and tear compared to traditional printed cards and boards. This enhances the longevity of the game components. Third, users may easily customize and personalize their games, adding unique elements such as player names, specific game rules, and real-time modifications. This adds a new dimension of engagement and personalization to the gaming experience. Fourth, the compact and reprogrammable nature of the game components makes the game pieces highly portable. Users can easily carry a complete game library on trips without the bulk and weight of traditional game sets. Fifth, users have an ability to modify game components during gameplay, such as adding power-ups or tracking player progress. This creates a more interactive and dynamic gaming experience which is especially appealing for modern gamers looking for innovative and engaging gameplay.

The present embodiments also provide environmental benefits by reducing the need for multiple physical game sets and minimizing waste. The present embodiments may also be useful in educational settings, where teachers can quickly adapt and modify learning games to suit different lessons and student needs. The present embodiments may also be useful for rapid prototyping for game developers who can quickly iterate and test new game designs without the cost and time associated with traditional printing and shipping. Developers may simply send a software update to a game library and testers may print out new cards and/or board pieces. This may accelerate the development process and allows for more innovative game designs.

Referring now to FIG. 3, an embodiment of a printer 300 and a plurality of game pieces is illustrated in accordance with some embodiments described herein. As shown in FIG. 3, a plurality of blank game cards and/or board pieces 302 are stacked on a feeder for the printer 300. The plurality of blank game cards and/or board pieces 302 may be fed into the printer 300 for printing. Once printed, the plurality of blank game cards and/or board pieces 302 may exit the printer at slot 304 and they are now fully printed game cards and/or board pieces 306. In some embodiments, the printer 300 may comprise the gaming interface 100 as described with respecting to FIG. 1. In this regard, the printer and the game interface may comprise a single device.

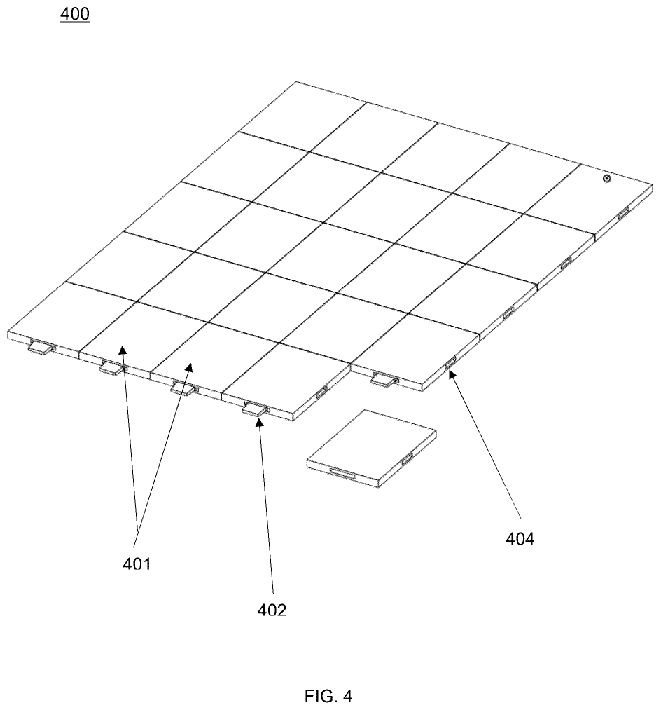

Referring now to FIG. 4, a game board 400 is illustrated in accordance with some embodiments described herein. The game board 400 comprises a plurality of pieces 401. The plurality of pieces may be interconnected via a plurality of couplers (402/404) to form the game board 400. The plurality of couplers may comprise male couplers 402 and female couplers 404. In some embodiments, the couplers 402/404 may be magnetic couplers or the game board 400 may be coupled using flexible sheet magnets with a printable surface used for making the game board as an optional alternative to interlocking game board pieces.

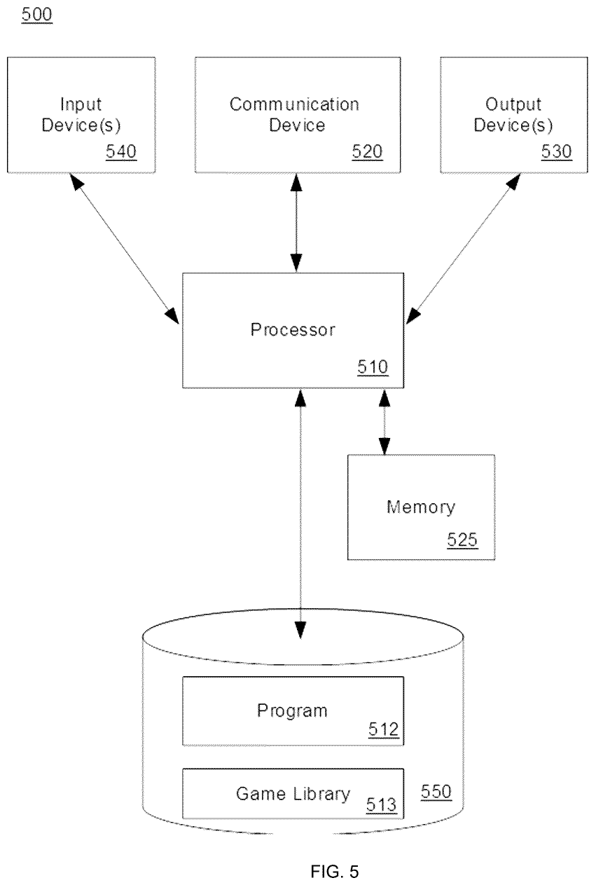

Note the embodiments described herein may be implemented using any number of different hardware configurations. For example, FIG. 5 illustrates a device 500 that may be, for example, be similar to the device 100 of FIG. 1. The device 500 may provide a technical and commercial advantage by being able to function as a gaming interface to perform the methods described herein.

The device 500 may comprise a processor 510 (“processor”), such as one or more commercially available Central Processing Units (CPUs) in the form of one-chip microprocessors, coupled to a communication device 520 configured to communicate via a communication network (not shown in FIG. 5). The communication device 520 may be used to communicate, for example, with one or more printers on a network. The device 500 further includes an input device 540 (e.g., a mouse, touch screen and/or keyboard to enter information) and an output device 530 (e.g., to output and display game information).

The processor 510 also communicates with a memory 325 and storage device 350 that stores data 513. The storage device 550 may comprise any appropriate information storage device, including combinations of magnetic storage devices (e.g., a hard disk drive), optical storage devices, mobile telephones, and/or semiconductor memory devices. The storage device 350 may store a program 512 and/or a game library 513 used for controlling the processor 510. The processor 310 performs instructions of the programs 512 and the game library 513, and thereby operates in accordance with any of the embodiments described herein. For example, the processor 510 may receive selection of a game from user which may be sent to the processor 510 to institute print information associated with the game via the instructions of the programs 512 and the game library 513.

The programs 512 may be stored in a compiled, compressed, uncompiled and/or encrypted format or a combination. The programs 512 may furthermore include other program elements, such as an operating system, a database management system, and/or device drivers used by the processor 510 to interface with peripheral devices.

As will be appreciated by one skilled in the art, the present embodiments may be embodied as a system, method or computer program product. Accordingly, the embodiments described herein may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the embodiments described herein may take the form of a computer program product embodied in one or more computer readable medium(s) having computer readable program code embodied thereon.

The process flow and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

This written description uses examples to disclose multiple embodiments, including the preferred embodiments, and also to enable any person skilled in the art to practice the invention, including making and using any devices or systems and performing any incorporated methods. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed:

1. A gaming system, comprising:
a first shaped game piece capable of comprising a reversible pigment; and
a second shaped game piece capable of comprising a reversible pigment.

2. The gaming system of claim 1, wherein the first shaped game piece and the second shaped game piece comprise a same shape.

3. The gaming system of claim 2, wherein the reversible pigment comprises a thermochromatic pigment.

4. The gaming system of claim 2, wherein the reversible pigment comprises e-ink or a rewrite-able display technology.

5. The gaming system of claim 3, wherein the first shaped piece is playing card shaped and the second shaped piece is playing card shaped.

6. The gaming system of claim 4, wherein the first shaped piece and the second shaped piece are comprised of plastic, paper, cardboard or a combination thereof.

7. The gaming system of claim 3, wherein the first shaped piece interlocks with the second shaped piece.

8. The gaming system of claim 2, wherein the thermochromatic pigment is erased based on exposing the first shaped piece and the second shaped piece to set temperature for a set period of time.

9. The gaming system of claim 1, further comprising a non-transitory computer readable medium that when executed by a processor performs a method, the method comprising:
providing a user interface for selection of a particular game;
receiving an indication of a selection of the particular game; and
transmitting game related information to a printer for printing on the first shaped game piece and the second shaped game piece.

10. The gaming system of claim 9, wherein the game related information comprises artwork and information to be printed on the first shaped game piece and the second shaped game piece.

11. The gaming system of claim 9 further comprising:
a printer configured to receive the first shaped game piece and the second shaped game piece.

12. The gaming system of claim 11, wherein the printer comprises a thermal printer.

13. The gaming system of claim 9 wherein, the method further comprises: modifying the game related information on the first shaped game piece and the second shaped game piece during gameplay to add power-ups, track player progress, or customize game elements with player-specific information.

14. A gaming system, comprising:
a first card shaped game piece capable of receiving a reversible thermochromatic pigment;
a second card shaped game piece capable of receiving a reversible thermochromatic pigment wherein the first card shaped piece and the second card shaped piece are comprised of plastic, paper, cardboard or a combination thereof; and
a non-transitory computer readable medium that when executed by a processor performs a method, the method comprising:
providing a user interface for selection of a particular game;
receiving an indication of a selection of the particular game; and
transmitting game related information to a printer for printing a thermochromatic pigment on the first card shaped game piece and the second card shaped game piece.

15. The gaming system of claim 14, wherein the method further comprises modifying the game related information on the first shaped game piece and the second shaped game piece during gameplay to add power-ups, track player progress, or customize game elements with player-specific information.

16. The gaming system of claim 14, wherein the thermochromatic pigment fades in cold temperatures.

17. The gaming system of claim 14, further comprising:
a thermal printer configured to receive the first shaped game piece and the first shaped game piece.

18. A gaming system, comprising:
a first shaped interlocking game piece capable of receiving a reversible thermochromatic pigment;
a second shaped interlocking game piece capable of receiving a reversible thermochromatic pigment, wherein the first interlocking game piece interlocks with the second interlocking game piece;
a non-transitory computer readable medium that when executed by a processor performs a method, the method comprising:
providing a user interface for selection of a particular game;
receiving an indication of a selection of the particular game; and
transmitting game related information to a thermal printer for printing a thermochromatic pigment on the first shaped interlocking game piece and the second shaped interlocking game piece; and
a thermal printer configured to receive the first shaped game piece and the second shaped game piece.

19. The gaming system of claim 17, wherein the first shaped piece interlocks with the second shaped piece.

20. The gaming system of claim 17, wherein the thermochromatic pigment fades in cold temperatures.
